(19) United States
(12) Patent Application Publication
(10) Pub. No.: US 2020/0162803 A1
(43) Pub. Date: May 21, 2020

(54) PADDLE BOARD WIRELESS COMMUNICATION DEVICE AND SYSTEM

(71) Applicant: Jeffrey Gillikin, Stuart, FL (US)

(72) Inventor: Jeffrey Gillikin, Stuart, FL (US)

(21) Appl. No.: 15/856,471

(22) Filed: Dec. 28, 2017

(51) Int. Cl. H04R 1/02; H04W 76/14; G06F 3/16; B63B 35/79; B63B 35/85

(52) U.S. Cl. CPC H04R 1/028; H04W 76/14; H04R 2420/07; B63B 35/79; B63B 35/85; G06F 3/165

(57) ABSTRACT

A wireless communication system, including a paddle board to float on water and to allow a user to stand thereupon while the paddle board floats on the water, a paddle to allow the user to paddle through the water while the user is standing on the paddle board, and a mobile device attached to the paddle board such that at least one speaker disposed on the paddle board plays music stored on the mobile device, wherein the paddle communicates with the mobile device to control the music playing on the at least one speaker.

### BACKGROUND OF THE INVENTION

### 1. Field of the Invention

The present general inventive concept relates generally to a paddle board, and more specifically, to a paddle board communication device and system that communicates with a mobile device.

### 2. Description of the Related Art

Paddle-boarding is an activity that is enjoyed by many sports enthusiasts. Recently with the introduction of waterproof headsets, many paddle-boarders enjoy listening to music that is stored on music-players or mobile devices (e.g., mobile telephones) when they are on the water. However, if a paddle-boarder's music-player or mobile device becomes wet during a paddle-boarding excursion, the music-player or mobile device will most likely be damaged.

Therefore, there is a need for a system to allow users to listen to music while they are paddle-boarding on water, and a paddle board that plays music stored on a mobile device.

### SUMMARY

The present general inventive concept provides a paddle board communication device and system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a wireless communication system, including a paddle board to float on water and to allow a user to stand thereupon while the paddle board floats on the water, a paddle to allow the user to paddle through the water while the user is standing on the paddle board, and a mobile device attached to the paddle board such that at least one speaker disposed on the paddle board plays music stored on the mobile device, wherein the paddle communicates with the mobile device to control the music playing on the at least one speaker.

The wireless communication system may further include a headset to communicate with the mobile device such that the music plays on the headset instead of the speakers when the headset is wirelessly paired with the mobile device.

The foregoing and/or other features and utilities of the present general inventive concept may also be achieved by providing a paddle board having a mobile device connected thereto, the paddle board including at least one speaker to play music stored on the mobile device, and a paddle to allow a user to paddle through the water while the user is standing on the paddle board, and to control the music playing on the at least one speaker.

The paddle may be wirelessly connected to the mobile device.

The paddle may include a handle, a pole connected to the handle, the pole storing a battery therein, and a control panel disposed on the handle, the control panel including a power button to allow power to be supplied from the battery to the control panel, a volume control button to control a volume level of the at least one speaker, and a track control button to allow the user to skip music tracks playing on the mobile device.

The paddle may further include a BLUETOOTH pairing button to allow the paddle to be paired with the mobile device upon a depression of the BLUETOOTH pairing button.

The BLUETOOTH pairing button allows the user to answer a phone call received on the mobile device.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top view of a paddle board communication system, according to an exemplary embodiment of the present general inventive concept; and

FIG. 2 is a side view illustrating the paddle board, according to an exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

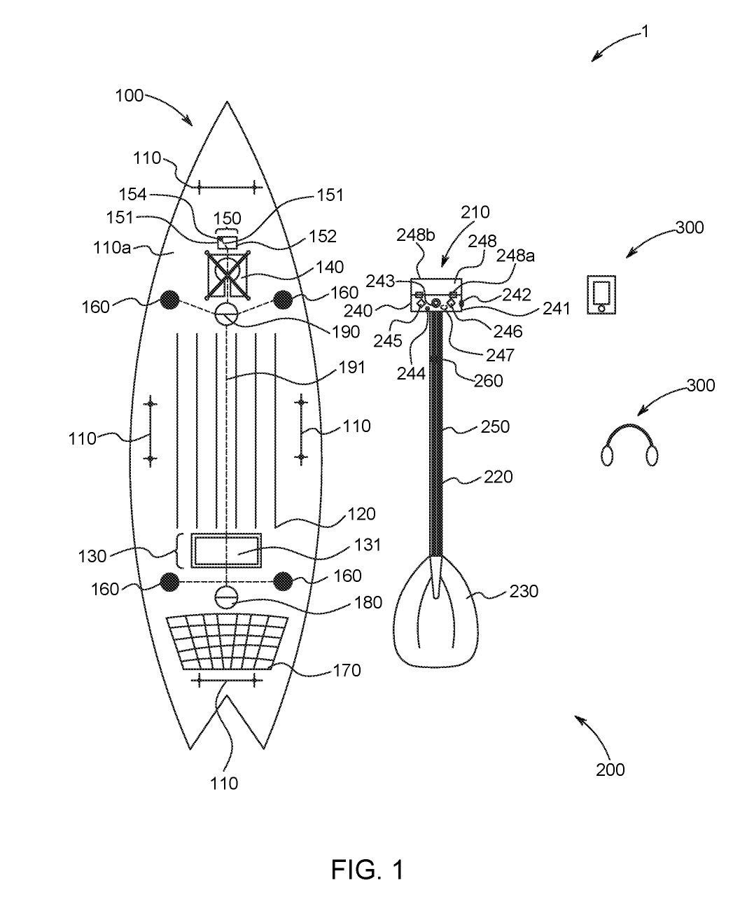

FIG. 1 illustrates a top view of a paddle board communication system 1, according to an exemplary embodiment of the present general inventive concept.

Referring to FIG. 1, the paddle board communication system 1 may include a paddle board 100, a paddle 200, a mobile device 300, and a headset 400.

The paddle board 100 may be any type of board that may float on water, such as a surf board, boogie-board, or any other type of board, which allows a user to lay, kneel, and/or stand thereupon as the paddle board floats on the water.

The paddle board 100 may be constructed from plastic, fiberglass, wood, or any other type of waterproof and floatable material. As such, if electrical components or devices are disposed within any portion of the paddle board 100, the electrical components or devices cannot become wet even if the paddle board 100 is submerged in water.

The paddle 200 may be any type of a paddle that allows the user to paddle while standing on the paddle board 100.

The mobile device 300 may be any type of wireless communicable mobile device, including, but not limited to, a mobile telephone, a laptop computer, a tablet computer, a palm pilot, a smart-watch, etc. As such, the mobile device 300 may have an ability to access the Internet via any available wired or wireless technology, and may include components such as a display device (e.g., touch screed, LED, LCD, plasma, etc.), an input unit (e.g., keyboard, touchpad, mouse, etc.), a camera (e.g., video camera, still camera, etc.), a processor, a storage unit, a communication unit, and an output unit (i.e., speakers, etc.).

The headset 400 may be any type of waterproof wireless communicable headset or headphones to allow the user to listen to music stored on the mobile device 300 (i.e., when the mobile device 300 plays the stored music), and/or to allow the user to receive telephone calls from the mobile device 300. For example, the headset 400 may be paired to the paddle board 100, the paddle 200, and/or the mobile device 300, via BLUETOOTH, or any other wireless technology.

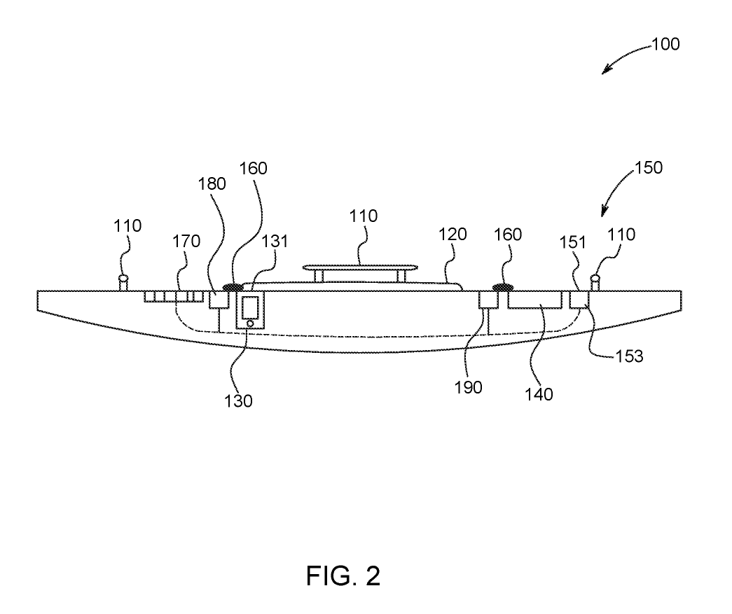

FIG. 2 is a side view illustrating the paddle board 100, according to an exemplary embodiment of the present general inventive concept.

Referring to FIGS. 1 and 2, the paddle board 100 may include at least one handle 110, a non-slip surface portion 120, a cooler 130, a life jacket compartment 140, a mobile device compartment 150, at least one speaker 160, a solar panel 170, a battery 180, and a printed circuit board (PCB) 190.

A top surface 100a of the paddle board 100 may include the at least one handle 110 disposed thereon to allow the user to hold onto the paddle board 100.

The top surface 100a may also include the non-slip surface portion 120 in order to prevent the user from slipping off the paddle board 100 when the user stands thereupon. The non-slip surface portion 120 may be made from rubber or any other type of non-slip surface material, and may be provided in lines, dots, or any other type of pattern.

The cooler 130 may be an insulated cooler disposed underneath a cooler door 131 that is disposed on the top surface 100a, to allow a few beverages to be disposed within the cooler 130.

The life jacket compartment 140 may include a life jacket disposed thereinside to be optionally available for the user's safety.

The mobile device compartment 150 may include a mobile device compartment door 151 that is sealed with a sealing portion 152, so that the mobile device 300 does not get wet when stored within the mobile device compartment 150. The sealing portion 152 may be rubber or any other type of material to provide a waterproof seal that prevents water from entering the mobile device compartment 150 when the mobile device compartment door 151 is closed. As such, the mobile device 300 may be stored within the mobile device compartment 150 without becoming wet, even if the paddle board 100 is submerged within water.

The mobile device compartment 150 may also include a mobile device connector 153 to connect to the mobile device 300, in order to allow the mobile device 300 to be electrically connected to the at least one speaker 160, the solar panel 170, the battery 180, and the PCB 190.

Additionally, the mobile device compartment 150 may include a power button/switch 154, which allows power to be provided from the battery 180 to the at least one speaker 160 and the PCB 190.

The at least one speaker 160 can be connected to the mobile phone 300 via any of the aforementioned wireless communication methods, such that music stored or playing on the mobile phone 300 is playable on the at least one speaker 160. Also, the at least one speaker 160 can act as a microphone to allow a user to communicate with a person on another end of a telephone call, if the telephone call is received on the mobile device 300.

The solar panel 170 may harness solar energy from the Sun and convert the Sun's energy into usable power to be provided to charge the battery 180, and/or to directly provide power the PCB 190, the at least one speaker 160, and the mobile device 300 via the mobile device connector 153.

The battery 180 may provide power to each of the components within the paddle board 100, including, but not limited to, the at least one speaker 160, the PCB 190, and the mobile device 300, via the mobile device connector 153.

PCB 190 may include conduits 191 to electrically connect all components within the paddle board 100, including, but not limited to, the mobile device connector 153, the at least one speaker 160, the solar panel 170, the battery 180, and the PCB 190.

The paddle 200 may include a handle 210, a pole 220, a paddle surface 230, a control panel 240, a communication module 250, and a battery 260.

The handle 210, the pole 220, and the paddle portion 230 may all be constructed from plastic, fiberglass, wood, or any other type of waterproof and floatable material. As such, if electrical components or devices are disposed within any of the handle 210, the pole 220, or the paddle surface 230, the electrical components or devices cannot become wet even if the paddle 200 is submerged in water.

The control panel 240, the communication module 250, and the battery 260 may all be disposed on and/or included within the handle 210.

Alternatively, the communication module 250 and/or the battery 260 may be disposed and/or included within the pole 220.

The control panel 240 may include a Universal Serial Bus (USB) charging port 241, a USB cover 242, a power button 243, a BLUETOOTH pairing button 244, a volume control button 245, a track control button 246, a printed circuit board (PCB) 247, and a control panel cover 248.

The USB charging port 241 may allow a user to plug the paddle 200 into an electrical socket using a USB cable, such that the battery 260 is charged.

The USB cover 242 may be made from a waterproof material (e.g., rubber) to prevent inner circuitry within the control panel 240 from becoming wet when the paddle 200 is submerged in water.

The power button 243 may allow the control panel 240 to be powered ON when a user pushes the power button 243, and then powered OFF when the user pushed the power button 243 again.

The BLUETOOTH pairing button 244 may allow the paddle 200 to be searchable by the mobile device 300, such that the paddle 200 may be connected to the mobile device 300. As such, when the BLUETOOTH pairing button 244 is depressed, it the paddle 200 becomes searchable by the mobile device 300 in a “pairing mode,” such that the user may see the paddle 200 as a pairable device on a screen of the mobile device 300.

The BLUETOOTH pairing button 244 may also act as a “Call Receive” button, which allows the user to answer a phone call coming through the mobile device 300 by depressing the BLUETOOTH pairing button 244, such that the at least one speaker 160 or the headset 400 allows for telephonic communications.

The volume control button 245 may allow the user to control the mobile device 300 that is paired with the paddle 200, in order to increase or decrease a volume level of music playing on the at least one speaker 160, or on the headset 400.

The track control button 246 may allow the user to change and/or skip tracks playing on the mobile device 300.

The power button 243, BLUETOOTH pairing button 244, the volume control button 245, and the track control button 246 may all include individually or in combination, a waterproof plastic covering, in order to prevent water from damaging the power button 243, BLUETOOTH pairing button 244, the volume control button 245, and the track control button 246, or any circuitry connected thereto.

The PCB 247 may include a storage unit, a processor, a receiver, a transmitter, and any other device to allow components within the control panel 240 to function properly.

The control panel cover 248 may be connected to the control panel 240 using hinges 248a or any other connection device. The control panel cove 248 may also include a watertight seal 248b disposed on an outer circumference thereof. As such, when the control panel cover 248 is closed, the watertight seal 248b prevents water from entering the control panel 240 when the paddle 200 is submerged.

The communication module 250 may include any type of wireless communication system, including, but not limited to, BLUETOOTH, radio frequency identification, near filed technology, WIFI, 3G, 4G, satellite, etc.

The communication module 250 may establish communication between the paddle 200 and the mobile device 300, when the mobile device 300 is connected to the paddle board 100. Even if the mobile device 300 is not connected to the paddle board 100, the paddle 200 may still be paired to the mobile device 300 via the communication module 250, using BLUETOOTH technology, for example.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A wireless communication system, comprising:
a paddle board to float on water and to allow a user to stand thereupon while the paddle board floats on the water;
a paddle to allow the user to paddle through the water while the user is standing on the paddle board; and
a mobile device attached to the paddle board such that at least one speaker disposed on the paddle board plays music stored on the mobile device, wherein the paddle communicates with the mobile device to control the music playing on the at least one speaker.

2. The wireless communication system of claim 1, further comprising:
a headset to communicate with the mobile device such that the music plays on the headset instead of the speakers when the headset is wirelessly paired with the mobile device.

3. A paddle board having a mobile device connected thereto, the paddle board comprising:
at least one speaker to play music stored on the mobile device; and
a paddle to allow a user to paddle through the water while the user is standing on the paddle board, and to control the music playing on the at least one speaker.

4. The paddle board of claim 3, wherein the paddle is wirelessly connected to the mobile device.

5. The paddle board of claim 4, wherein the paddle comprises:
a handle;
a pole connected to the handle, the pole storing a battery therein; and
a control panel disposed on the handle, the control panel comprising:
a power button to allow power to be supplied from the battery to the control panel,
a volume control button to control a volume level of the at least one speaker, and
a track control button to allow the user to skip music tracks playing on the mobile device.

6. The paddle board of claim 5, wherein the paddle further comprises:
a BLUETOOTH pairing button to allow the paddle to be paired with the mobile device upon a depression of the BLUETOOTH pairing button.

7. The paddle board of claim 6, wherein the BLUETOOTH pairing button allows the user to answer a phone call received on the mobile device.
